(19) United States
(12) Patent Application Publication
(10) Pub. No.: US 2011/0024388 A1
(43) Pub. Date: Feb. 3, 2011

(54) METHOD FOR MANUFACTURING MAGNETIC RECORDING MEDIUM

(75) Inventors: Takahiro SUWA, Tokyo (JP); Narutoshi Fukuzawa, Tokyo (JP); Shuichi Okawa, Tokyo (JP); Yoshinori Uchiyama, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/842,502

(22) Filed: Jul. 23, 2010

(30) Foreign Application Priority Data
Jul. 28, 2009 (JP) 2009-174999

(51) Int. Cl. G11B 5/84

(52) U.S. Cl. 216/22

(57) ABSTRACT

A method for manufacturing a magnetic recording medium is provided which can sufficiently reduce variations in surface roughness even in the simultaneous presence of a region of a relatively wide concave and convex portion and a region of a relatively narrow concave and convex portion in the recording layer. The method includes the steps of etching a recording layer based on a (first) mask layer to process it in a concavo-convex pattern, and depositing a filler over the recording layer and the mask layer to fill a concave portion with the filler. In between those steps, provided is the step of removing part of the first mask layer over a recording element (a convex portion of the recording layer) by dry etching in which an etching rate for the mask layer is higher than that for the recording layer so that the mask layer remains over the recording element.

### TECHNICAL FIELD

The present invention relates to a method for manufacturing a magnetic recording medium having a recording layer formed in a concave-convex pattern.

### BACKGROUND ART

Conventional magnetic recording media such as hard disks have been significantly improved in areal density, for example, by employing finer magnetic particles or alternative materials for the recording layer and advanced microprocessing for the head. Although further improvements in areal density are still in demand, these conventional approaches to the improvement of areal density have already reached their limits due to several problems that have come to the surface. These problems include the limited accuracy of microprocessing of the head, erroneous recording of information on a track adjacent to the target track due to spread of the magnetic field, and crosstalk.

In this context, as candidate magnetic recording media that enable further improvements in areal density, discrete track media or patterned media have been suggested which have a recording layer formed in a concave-convex pattern. The discrete track medium has a recording layer formed in a concave-convex pattern corresponding to tracks in the data region. On the other hand, the patterned medium has a recording layer formed in a concavo-convex pattern corresponding to recording bits in the data region. Note that it has also been suggested for the discrete track medium and the patterned medium that the servo region of the recording layer is formed in a concavo-convex pattern corresponding to a servo pattern.

On the other hand, for magnetic recording media such as hard disks, large surface protrusions and recesses cause the flying height of the head slider to be unstable. It has thus been suggested for the discrete track medium and the patterned medium that a filler is deposited over the concavo-convex pattern recording layer to fill the concave portion of the recording layer with the filler, and then the surface of the recording layer is flattened by removing the excessive portion of the filler. The filler may be deposited by sputtering or the like. Furthermore, the excessive portion of the filler may be removed by dry etching such as by IBE (Ion Beam Etching) or RIE (Reactive Ion Etching). The filler is deposited in a concavo-convex pattern to follow the recording layer of the concavo-convex pattern. However, since the dry etching tends to be higher in etching rate at the convex portion than at the concave portion, it has been expected that sufficiently flattened surface should be provided by dry etching.

However, the etching rate of the dry etching tends to be greater at a narrow convex portion than at a wide convex portion. Nevertheless, the recording layer sometimes includes a region of a relatively wide convex portion and a region of a relatively narrow convex portion at the same time. Thus, it was likely to happen that one region could be flattened satisfactorily but not both. For example, it was suggested for the discrete track medium and the patterned medium that the servo region of the recording layer is formed in the concavo-convex pattern corresponding to the servo pattern, as described above. The recording layer in the servo region may often have convex and concave portions of a width that is greater than the width of the convex and concave portions of the recording layer in the data region. Accordingly, when etching conditions such as etching time are so set as to sufficiently flatten the surface of either one of the servo region and the data region, the other region would likely be etched insufficiently or otherwise excessively, leaving the surface being unsatisfactorily flattened.

In this context, another technique has been suggested (for example, see Patent Literature 1). This method includes the steps of depositing a filler over a workpiece, with a temporary underlying material formed on the convex portion of its recording layer, to fill the concave portion with the filler, and removing an excessive portion of the filler, so as to expose at least the side of the temporary underlying material, by dry etching that tends to selectively etch the convex portion at a higher rate than at the concave portion. The method further includes the step of removing the temporary underlying material by the etching in which an etching rate for the temporary underlying material is higher than that for the filler. In this manner, such an etching method that provides a higher etching rate for the temporary underlying material than for the filler may be used to selectively remove the temporary underlying material. While the filler of the concave portion is being less etched, this makes it possible to remove the entire convex portion made up of the temporary underlying material or the entire convex portion made up of the temporary underlying material and the filler in a short period of time irrespective of their width. It was thus believed that even in the simultaneous presence of a region of a relatively wide concave or convex portion and a region of a relatively narrow concave or convex portion in the recording layer, this method would serve to flatten the surface sufficiently with less variations in surface roughness.

Citation List

Patent Literature

### Patent Literature 1: Japanese Patent Application Laid-Open No. 2006-196143

### SUMMARY OF INVENTION

### Technical Problem

However, even the aforementioned technique using the temporary underlying material could not sufficiently reduce variations in surface roughness to provide sufficiently flattened surface when a region of a relatively wide concave and convex portion and a region of a relatively narrow concave and convex portion are present in the recording layer at the same time.

In view of the foregoing problems, various exemplary embodiments of this invention provide a method for manufacturing magnetic recording media which is capable of sufficiently reducing variations in surface roughness even in the simultaneous presence of a region of a relatively wide concave and convex portion and a region of a relatively narrow concave and convex portion in the recording layer.

### Solution to Problem

Various exemplary embodiments of the present invention achieve the aforementioned object by providing a method as follows. The method includes the steps of etching a recording layer based on a mask layer into a concavo-convex pattern and depositing a filler over the recording layer and the mask layer to fill a concave portion of the concavo-convex pattern with the filler. In between these steps, the method further includes the step of removing part of the mask layer over the convex portion of the recording layer by dry etching in which an etching rate for the mask layer is higher than that for the recording layer so that the mask layer remains over the convex portion of the recording layer.

On the way to reach the idea of the present invention, the inventors conducted intensive studies to find the reason that variations in surface roughness could not be sufficiently reduced and thus provide sufficiently flattened surfaces even using the aforementioned conventional technique when a region of a relatively wide concave or convex portion and a region of a relatively narrow concave or convex portion were present in the recording layer at the same time. As a result, the following fact was found. In the step of etching the filler that has been formed in the concavo-convex pattern following the concavo-convex-patterned recording layer, the concave portion of the filler was etched at a relatively high etching rate in a region, such as the servo region, of a relatively wide concave portion, whereas the concave portion of the filler was etched at a relatively low etching rate in a region, such as the data region, of a relatively narrow concave portion. In other words, it was found that not only the convex portion but also the concave portion were etched at different etching rates depending on their width. This is thought to be because the concave portion of a high aspect ratio (the depth of the concave portion/the width of the concave portion) has its bottom that tends to be hidden behind the adjacent convex portions when being irradiated with a process gas in the step of etching the filler, so that the process gas cannot go easily into the bottom of the concave portion and thus the concave portion of the filler is etched at a relatively low etching rate. Note also that even when the surface of the workpiece was irradiated with the process gas in perpendicular direction to the surface (in parallel to the direction of depth of the concave portion), the greater the aspect ratio of the concave portion, the lower the etching rate of the concave portion tended to be, as expected. This is conceivably because even when the surface of the workpiece is irradiated with the process gas in the perpendicular direction, part of the gas is projected at a slant angle to the perpendicular direction, and the gas incident at a slant angle cannot easily go into the bottom of the concave portion of a high aspect ratio. When the filler is deposited over a workpiece with the temporary underlying material formed over the convex portion of the recording layer, the concave portion of the filler becomes deeper by the amount of the thickness of the temporary underlying material and has accordingly a greater aspect ratio as compared to the case where no temporary underlying material is formed over the convex portion of the recording layer. The concave portion of the filler was thus thought to be especially not easy to etch.

Etching may be stopped to suit to a region like the servo region with a relatively wide concave portion to be etched at a relatively high etching rate. This causes the concave portion of the filler to be insufficiently etched in a region like the data region with a relatively narrow concave portion to be etched at a relatively low etching rate. In contrast, etching may also be stopped to suit to a region like the data region with a relatively narrow concave portion to be etched at a relatively low etching rate. This causes the concave portion of the filler to be excessively etched in a region like the servo region with a relatively wide concave portion to be etched at a relatively high etching rate. It is thus thought that when a region of a relatively wide concave and convex portion and a region of a relatively narrow concave and convex portion are simultaneously present in the recording layer, variations in surface roughness could not be sufficiently reduced and thus sufficiently flattened surface could not be provided.

In contrast to this, provided is the step of removing part of a mask layer over a convex portion of a recording layer by dry etching in which an etching rate for the mask layer is higher than that for the recording layer so that the mask layer remains over the convex portion of the recording layer between the steps of etching the recording layer based on the mask layer into a concavo-convex pattern and depositing a filler over the recording layer and the mask layer to fill a concave portion of the concavo-convex pattern with the filler. This allows the aspect ratio of the concave portion of the filler deposited over the recording layer and the mask layer to be reduced as well as the bottom of the concave portion of the filler to be prevented from being hidden behind the adjacent convex portions in the step of etching the filler. Accordingly, the concave portion of the filler in a region of a relatively narrow concave portion can be prevented from being etched at a reduced etching rate. This allows the etching rate for the concave portion of the filler in a region, like the data region, of a relatively narrow concave portion to be close to the etching rate for the concave portion of the filler in a region, such as the servo region, of a relatively wide concave portion.

Note that the convex portion tends to be etched by dry etching faster at the central portion than at the peripheral portion. Thus, in the step of etching the mask layer over the convex portion of the recording layer, the peripheral portion of the mask layer may be removed faster than the central portion of the mask layer, thus causing the central portion of the mask layer to be etched less. In such a case, the concave portion of the filler deposited over the recording layer and the mask layer is not necessarily reduced sufficiently in depth. However, the peripheral portion of the mask layer over the convex portion of the recording layer is removed, thereby preventing the bottom of the concave portion of the filler from being hidden behind the adjacent convex portions in the step of etching the filler. Accordingly, also in this case, the etching rate of the concave portion of the filler can be prevented from being reduced.

Furthermore, after the filler has been etched, the mask layer is then selectively removed in a manner such that the mask layer is etched by an etching process in which an etching rate for the mask layer is higher than that for the filler While the filler of the concave portion is being etched less, this makes it possible to remove the entire convex portion formed of the mask layer or the entire convex portion formed of the mask layer and the filler remaining thereon in a short period of time irrespective of their width.

Accordingly, even in the simultaneous presence of a region of a relatively wide concave and convex portion and a region of a relatively narrow concave and convex portion in the recording layer, it is possible to sufficiently reduce variations in surface roughness.

Note that the mask layer deposited over the recording layer may be reduced in thickness from the beginning without the step of removing part of the mask layer by dry etching between the steps of processing the recording layer into a concavo-convex pattern and depositing the filler. Even in this case, it is possible to prevent the bottom of the concave portion of the filler deposited over the recording layer and the mask layer from being hidden behind the adjacent convex portions. However, as described above, the peripheral portion of the convex portion tends to be removed faster by dry etching than the central portion of the convex portion. Thus, etching the recording layer with the mask layer reduced in thickness from the beginning raises several problems. That is, in the course of the step of etching the recording layer, the peripheral portion of the mask layer (of the convex portion) vanishes causing the underlying recording layer to be etched, so that the convex portion of the recording layer is narrower than the target width. Additionally, the side of the convex portion of the recording layer may be processed to be angled more than intended. Furthermore, the peripheral portion of the mask layer (of the convex portion) may not vanish completely. Even in this case, when the peripheral portion of the mask layer (of the convex portion) has been etched to be excessively thin in the course of the step of etching the recording layer, the side of the convex portion of the recording layer may be processed to be angled more than intended.

In contrast to this, part of the mask layer over the convex portion of the recording layer is removed by dry etching in which an etching rate for the mask layer is higher than that for the recording layer so that the mask layer remains over the convex portion of the recording layer after the step of etching the recording based on the mask layer into a concavo-convex pattern. This makes it possible to keep the convex portion of the recording layer in shape as intended and prevent the bottom of the concave portion of the filler from being hidden behind the adjacent convex portions in the step of etching the filler deposited over the mask layer and the recording layer.

That is, the aforementioned object can be achieved by a method for manufacturing a magnetic recording medium, comprising: a preceding-stage mask layer processing step of processing a mask layer of a workpiece into a pattern corresponding to a predetermined concavo-convex pattern, the workpiece including a substrate, a recording layer, and the mask layer; a recording layer processing step of etching the recording layer based on the mask layer into the concavo-convex pattern by dry etching in which an etching rate for the recording layer is higher than that for the mask layer; a subsequent-stage mask layer processing step of removing part of the mask layer over a convex portion of the recording layer by dry etching in which an etching rate for the mask layer is higher than that for the recording layer so that the mask layer remains over the convex portion of the recording layer; a filler depositing step of depositing a filler of which material is different from a material of the mask layer over the recording layer and the mask layer to fill a concave portion of the concavo-convex pattern with the filler; a filler etching step of removing at least part of an excessive portion of the filler formed over the convex portion of the recording layer by dry etching so as to expose at least part of the mask layer remaining over the convex portion of the recording layer; and a mask layer removing step of flattening a surface by removing the mask layer by dry etching in which an etching rate for the mask layer is higher than that for the filler.

Alternatively, the aforementioned object can be achieved by a method for manufacturing a magnetic recording medium, comprising: a preceding-stage mask layer processing step of processing a mask layer of a workpiece into a pattern corresponding to a predetermined concavo-convex pattern, the workpiece including a substrate, a recording layer, and the mask layer; a recording layer processing step of etching the recording layer based on the mask layer into the concavo-convex pattern by dry etching in which an etching rate for the recording layer is higher than that for the mask layer; a subsequent-stage mask layer processing step of removing part of the mask layer over a convex portion of the recording layer by dry etching in which an etching rate for the mask layer is higher than that for the recording layer so that the mask layer remains over the convex portion of the recording layer; a filler depositing step of depositing a filler of which material is different from a material of the mask layer over the recording layer and the mask layer to fill a concave portion of the concavoconvex pattern with the filler; and a mask layer removing step of flattening a surface by removing the mask layer and an excessive portion of the filler formed over a convex portion of the recording layer by dry etching in which an etching rate for the mask layer is higher than that for the filler.

Note that as used herein, the phrase “the recording layer in the concavo-convex pattern” refers to, in addition to a recording layer that is formed by dividing a continuous recording layer into a predetermined pattern where the convex portions forming the recording elements are completely separated from each other, a recording layer in which the convex portions separated from each other in the data region are continuous near the boundary between the data region and the servo region. In addition, the phrase also refers, for example, to a recording layer which is formed continuously over part of the substrate, such as a helical spiral recording layer, or a recording layer whose concave portion is extended down to a position between the upper and lower surfaces of the recording layer and is continuous on the bottom of the concave portion.

Furthermore, as used herein, the term “etching rate” refers to the amount of processing per unit time.

Furthermore, as used herein, the term “magnetic recording media” refers to, but is not limited to, hard disks, floppy (registered trademark) disks, or magnetic tapes which employ only magnetism for recording and reproducing information, as well as magneto-optical recording media such as MO (Magneto Optical) media which employ both magnetism and light beams, and heat-assisted recording media which employ both magnetism and heat.

### Advantageous Effects of Invention

According to various exemplary embodiments of the present invention, it is possible to manufacture magnetic recording media without significant variations in surface roughness even in the simultaneous presence of a region of a relatively wide concave and convex portion and a region of a relatively narrow concave and convex portion in the recording layer.

### BRIEF DESCRIPTION OF DRAWINGS

FIG. 1 is a sectional side view schematically illustrating the structure of a starting body of a workpiece according to a first exemplary embodiment of the present invention;

FIG. 2 is a sectional side view schematically illustrating the structure of a magnetic recording medium obtained by processing the workpiece;

FIG. 3 is a flowchart showing the outline of the steps for manufacturing the magnetic recording medium;

FIG. 4 is a sectional side view schematically illustrating the shape of the workpiece with a pattern transferred to a resist layer;

FIG. 5 is a sectional side view schematically illustrating the shape of the workpiece with a first mask layer processed into a pattern;

FIG. 6 is a sectional side view schematically illustrating the shape of the workpiece with a recording layer processed into a concavo-convex pattern;

FIG. 7 is a sectional side view schematically illustrating the shape of the workpiece with part of the first mask layer over a recording element removed;

FIG. 8 is a sectional side view schematically illustrating the shape of the workpiece with a filler deposited thereover;

FIG. 9 is a sectional side view schematically illustrating the shape of the workpiece with the first mask layer over the recording element exposed by etching an excessive portion of the filler;

FIG. 10 is a sectional side view schematically illustrating another example of the shape of the workpiece with the first mask layer over the recording element exposed by etching an excessive portion of the filler;

FIG. 11 is a sectional side view schematically illustrating another example of the shape of the workpiece with the first mask layer over the recording element exposed by etching an excessive portion of the filler;

FIG. 12 is a sectional side view schematically illustrating the shape of the workpiece with the first mask layer removed and surfaces of the filler and a stopping film flattened;

FIG. 13 is a sectional side view schematically illustrating the shape of the workpiece with the stopping film removed;

FIG. 14 is a flowchart showing the outline of the steps for manufacturing a magnetic recording medium according to a second exemplary embodiment of the present invention;

FIG. 15 is a sectional side view schematically illustrating the shape of a workpiece according to a third exemplary embodiment of the present invention with a recording layer processed in a concavo-convex pattern; and

FIG. 16 is a flowchart showing the outline of the steps for manufacturing a magnetic recording medium according to a fourth exemplary embodiment of the present invention.

### DESCRIPTION OF EMBODIMENTS

Now, the present invention will be described below in more detail with reference to the accompanying drawings in accordance with the preferred exemplary embodiments.

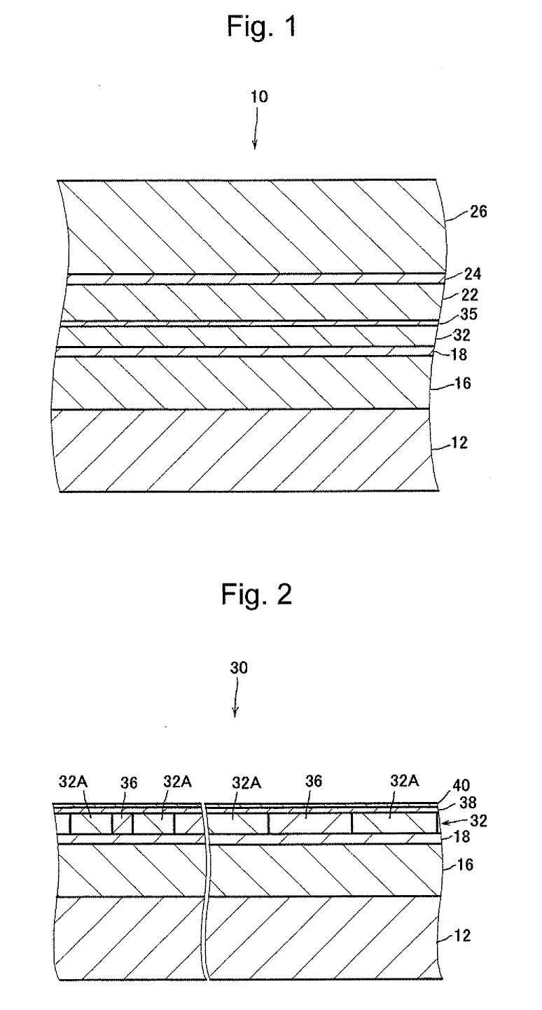

The first exemplary embodiment of the present invention relates to a method for manufacturing a magnetic recording medium 30 which has a recording layer 32 with a concavo-convex pattern formed therein as shown in FIG. 2 by processing a starting body of a workpiece 10, shown in FIG. 1, which has a substrate 12, a continuous film recording layer 32, and a first mask layer 22 and the like. The method includes the steps of etching the recording layer 32 based on the first mask layer 22 into a concavo-convex pattern, and depositing a filler 36 over the recording layer 32 and the first mask layer 22 to fill the concave portion of the concavo-convex pattern of the recording layer 32 with the filler 36. The method is characterized by providing in between these steps the step of removing part of the first mask layer 22 over a recording element 32A (the convex portion of the recording layer 32) by dry etching in which an etching rate for the first mask layer 22 is higher than that for the recording layer 32 so that the first mask layer 22 remains over the recording element 32A.

The starting body of the workpiece 10 includes the substrate 12, a soft magnetic layer 16, a seed layer 18, the recording layer (the continuous film not yet processed in a concavo-convex pattern), a stopping film 35, the first mask layer 22, a second mask layer 24, and a resin layer 26. These layers are formed in that order over the substrate 12.

The substrate 12 is made of glass, Al₂O₃ or the like. The soft magnetic layer 16 has a thickness of 50 to 300 nm. The soft magnetic layer 16 can be made of an Fe alloy, a Co alloy or the like. The seed layer 18 has a thickness of 2 to 40 nm. The seed layer 18 is made of a non-magnetic CoCr alloy, Ti, Ru, a stacked layer of Ru and Ta, MgO or the like.

The recording layer 32 has a thickness of 5 to 30 nm. The recording layer 32 may be made of a CoPt-based alloy such as a CoCrPt alloy, an FePt-based alloy, a stacked layer of these alloys, a material which contains ferromagnetic particles such as CoCrPt in the matrix of oxide-based materials such as SiO₂, or the like.

The stopping film 35 has a thickness of 1 to 10 nm. The stopping film 35 is made of Ta or the like.

The first mask layer 22 has a thickness of 3 to 50 nm. The first mask layer 22 can be made of a material mainly composed of carbon, such as a hard carbon film referred to as the DLC (diamond like carbon) deposited by CVD or the like or a carbon film deposited by sputtering or the like.

The second mask layer 24 has a thickness of 3 to 30 nm. The second mask layer 24 can be made of Ni, Si, SiO₂, Ta or the like. The resin layer 26 has a thickness of 30 to 300 nm. The resin layer 26 can be made of an ultraviolet curable resin, various types of photoresist material or the like.

The magnetic recording medium 30 is a perpendicular recording type discrete track medium. The data region portion of the recording layer 32 is shaped in a concavo-convex pattern where the data region portion is divided into a number of concentrically arc-shaped recording elements 32A radially at fine intervals. The concave portions between the recording elements 32A are filled with the filler 36. Furthermore, a protective layer 38 and a lubricant layer 40 are formed over the recording element 32A and the filler 36 in that order. Furthermore, the servo region portion of the recording layer 32 is formed in a concavo-convex pattern corresponding to a predetermined servo pattern. Most of the convex portion and the concave portion of the recording layer 32 in the servo region are greater in width than the convex portion and the concave portion of the recording layer in the data region.

The filler 36 can be made of, for example, SiO₂. The protective layer 38 has a thickness of 1 to 5 nm. The protective layer 38 can be made of DLC. The lubricant layer 40 has a thickness of 1 to 2 nm. The lubricant layer 40 can be made of PFPE (perfluoropolyether).

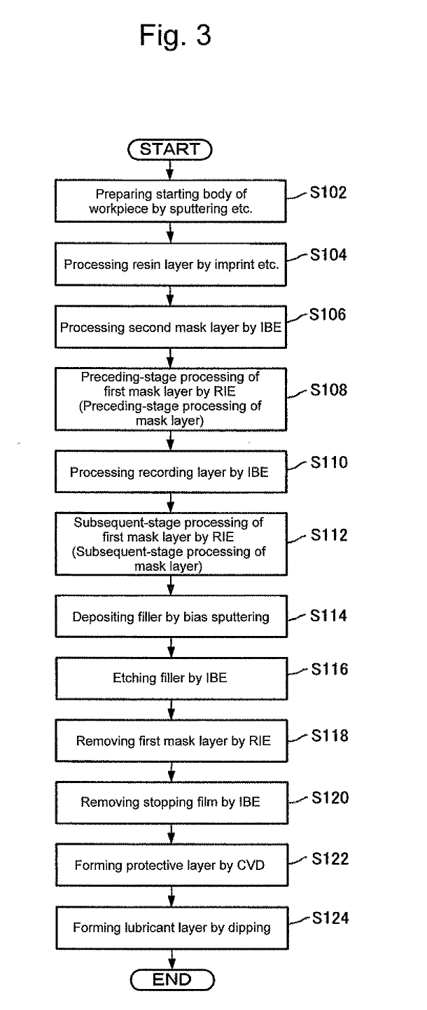

Now, referring to the flowchart shown in FIG. 3, a description will be made to a method of processing the workplace 10.

First, the starting body of the workpiece 10 shown in FIG. 1 is prepared (S102: the starting body of workplace preparing step). The starting body of the workpiece 10 is obtained by forming the soft magnetic layer 16, the seed layer 18, the recording layer 32 (the continuous film not yet processed in the concavo-convex pattern), the stopping film 35, the first mask layer 22, and the second mask layer 24 over the substrate 12 by sputtering in that order and then by applying the resin layer 26 thereto by spin coating.

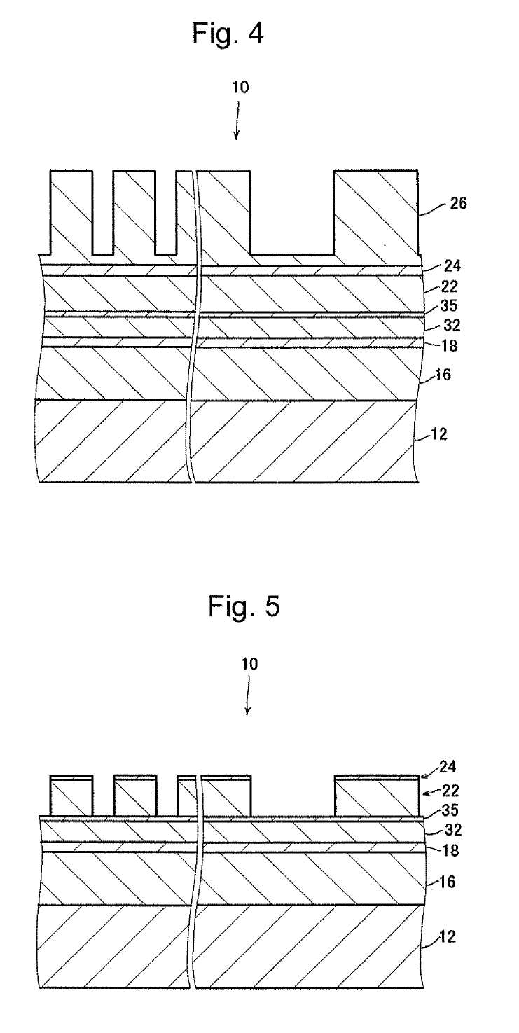

Next, as shown in FIG. 4, the resin layer 26 of the starting body of the workplace 10 is processed in the pattern corresponding to the concavo-convex pattern of the recording layer 32 (S104: the resin layer processing step). More specifically, the concavo-convex pattern corresponding to the predetermined servo pattern and track pattern is transferred to the resin layer 26 by imprinting using a transfer apparatus (not shown). Note that the resin layer 26 may be exposed and developed so that the resin layer 26 is processed in the pattern corresponding to the concavo-convex pattern of the recording layer 32.

Next, by IBE using an Ar gas, the second mask layer 24 is etched based on the resin layer 26, so that the second mask layer 24 is processed in a pattern corresponding to the concavo-convex pattern of the recording layer 32 (S106: the second mask layer processing step). The incident angle is set, for example, at 90 degrees. Note that as used herein, the term “IBE” collectively refers to a processing method, such as the ion milling, for irradiating the workpiece with an ionized gas to remove the object to be processed. Furthermore, as used herein, the term “incident angle” refers to the incident angle to the surface of a workpiece or the angle which is formed between the surface of the workpiece and the center axis of the ion beam. For example, when the center axis of the ion beam is perpendicular to the surface of the workpiece, the incident angle is 90 degrees, while with the center axis of the ion beam being parallel to the surface of the workpiece, the incident angle is 0 degrees. Note that when the resin layer processing step (S104) is performed by imprinting, the resin layer 26 may remain at the bottom of the concave portion; however, in this step (S106), the bottom of the concave portion of the resin layer 26 is also removed.

Now, as shown in FIG. 5, the first mask layer 22 is etched based on the second mask layer 24 by RIE using a O₂ or O₃ gas, so that the first mask layer 22 is processed in a pattern corresponding to the concavo-convex pattern of the recording layer 32 (S108: the preceding-stage first mask layer processing step (the preceding-stage mask layer processing step)). Note that as used herein, the term “RIE” will refer to etching using an RIE apparatus even when using a gas such as a noble gas which does not chemically react with the object to be processed.

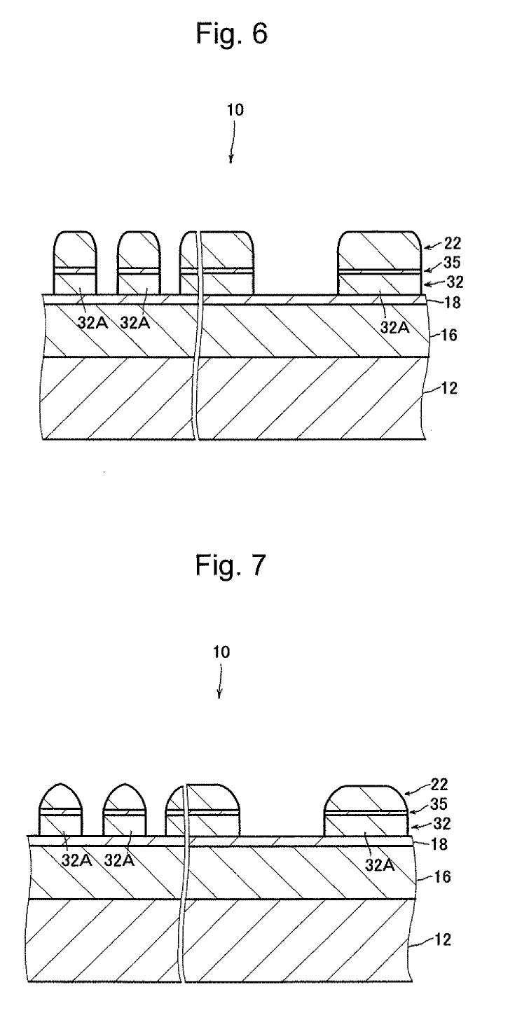

Now, as shown in FIG. 6, the recording layer 32 is etched based on the first mask layer 22 by dry etching in which an etching rate for the recording layer 32 is higher than that for the first mask layer 22 and thus processed in the intended concavo-convex pattern (S110: the recording layer processing step). At this time, the stopping film 35 is also etched in conjunction with the recording layer 32. Furthermore, in this step (S110), the recording layer 32 and the stopping film 35 are etched so that the first mask layer 22 remains over the recording element 32A (or on the stopping film 35). On the other hand, in this step (S110), the second mask layer 24 will disappear. IBE using an Ar gas can be employed as the dry etching. The incident angle is set, for example, to 90 degrees.

Now, as shown in FIG. 7, part of the first mask layer 22 over the recording element 32A is removed by dry etching in which an etching rate for the first mask layer 22 is higher than that for the recording layer 32 so that the first mask layer 22 remains over the recording element 32A (the convex portion of the recording layer 32) (S112: the subsequent-stage first mask layer processing step (the subsequent-stage mask layer processing step)). RIE using a reactive gas that chemically reacts with the first mask layer 22 to remove the first mask layer 22 can be employed as the dry etching. The reactive gas may be any one of the gases, for example, an oxygen-based gas such as an O₂ or O₃ gas, a fluorine-based gas such as SF₆, CF₄, or C₂F₆, a chlorine-based gas such as Cl₂ or BCl₃, or a nitrogen-based gas such as N₂ or NH₃. With an oxygen-based gas employed as the reactive gas, the side of the recording element 32A can be oxidized to enhance the coercivity of the side portion of the recording element 32A. Enhancing the coercivity in this manner can serve to prevent erroneous recording of information on the recording elements 32A adjacent to the target recording element 32A. On the other hand, with a fluorine-based gas, a chlorine-based gas, or a nitrogen-based gas employed as the reactive gas, the magnetism of the side portion of the recording element 32A can be eliminated to separate the adjacent recording elements 32A magnetically in a clear manner. Furthermore, for example, in the recording layer processing step (S110), the recording layer 32 may not be completely divided, and the recording layer 32 may be etched so that the recording layer remains at the bottom of the concave portion between the recording elements 32A. In such a case, the magnetism of the portion remaining at the bottom of the concave portion in the recording layer 32 can be removed, thereby separating the adjacent recording elements 32A magnetically in a clear manner. Peripheral and central portions of the first mask layer 22 over the recording element 32A may be removed equally. Alternatively, as shown in FIG. 7, the peripheral portion of the first mask layer 22 over the recording element 32A may be removed more than the central portion. It is nevertheless preferable that the first mask layer 22 remain on the entire surface (of the upper surface of the stopping film 35) over the recording element 32A.

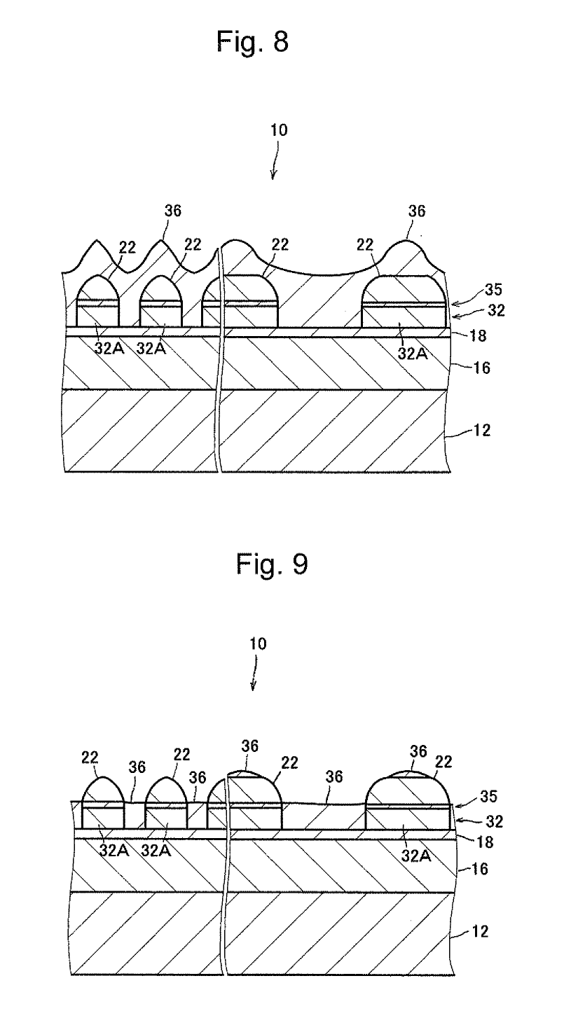

Next, as shown in FIG. 8, the filler 36 such as SiO₂, different from the material of the first mask layer 22, is deposited over the recording layer 32 and the first mask layer 22 by bias sputtering to fill the concave portion of the concavo-convex pattern of the recording layer 32 with the filler 36 (S114: the filler depositing step). The particles of the filler 36 tend to be deposited uniformly on the surface of the workpiece 10, resulting in the surface being shaped in protrusions and recesses. On the other hand, since part of the first mask layer 22 over the recording element 32A has been removed in the subsequent-stage mask layer processing step (S112), the protrusions and recesses of the surface of the filler 36 are reduced accordingly. Furthermore, applying a bias voltage to the workpiece 10 causes the sputtering gas to be biased towards the workpiece 10 and collide with the deposited filler 36, thereby etching part of the deposited filler 36. This etching operation tends to selectively remove a projecting portion of the deposited filler 36 faster than the other portion, so that the protrusions and recesses are reduced on the surface of the filler 36. In particular, the first mask layer 22 remaining over the recording element 32A causes the convex portion of the filler 36 over the recording element 32A to protrude more than that of the filler 36 deposited over the recording element 32A with no first mask layer 22 left thereon. Accordingly, the convex portion of the filler 36 over the recording element 32A is thus prominently selectively removed faster than the other portion of the filler 36, allowing the protrusions and recesses of the surface of the filler 36 to be significantly reduced. The filler 36 continues to be deposited by the deposition operation being performed in excess of the etching operation, while variations in the protrusions and recesses of the surface are being prevented. As such, as shown in FIG. 8, the filler 36 is deposited to cover the recording layer 32 and the first mask layer 22 with the protrusions and recesses of the surface reduced to some extent, so that the concave portion of the concavo-convex pattern of the recording layer 32 is filled with the filler 36. Note that FIG. 8 shows a more enhanced shape of protrusions and recesses than the actual one for better understanding of the first exemplary embodiment.

Next, as shown in FIG. 9, at least part of an excessive portion of the filler 36, formed above the recording element 32A (the convex portion of the recording layer), is removed by dry etching so as to expose at least part of the first mask layer 22 remaining over the recording element 32A (the convex portion of the recording layer) (S116: the filler etching step). IBE using, for example, an Ar gas can be employed as the dry etching. The incident angle is set, for example, to 90 degrees.

Part of the first mask layer 22 over the recording element 32A is removed in the subsequent-stage mask layer processing step (S112), so that the protrusions and recesses of the surface of the filler 36 deposited in the filler depositing step (S114) are accordingly reduced. This prevents the bottom of the concave portion of the filler 36 from being hidden behind the adjacent convex portions. It is thus possible to prevent the concave portion of the filler 36 from being etched at a reduced etching rate in a region, like the data region, of a relatively narrow concave portion. Therefore, the etching rate for the concave portion of the filler 36 in a region, like the data region, of a relatively narrow concave portion can be made close to the etching rate for the concave portion of the filler 36 in a region, such as the servo region, of a relatively wide concave portion.

Furthermore, the convex portion tends to be selectively removed faster than the concave portion by dry etching. It is thus possible to efficiently remove the filler 36 that covers the first mask layer 22 remaining over the recording element 32A. In particular, since the first mask layer 22 remains over the recording element 32A, the convex portion of the filler 36 over the recording element 32A is protruded more than that of the filler 36 deposited over the recording element 32A with no first mask layer 22 left thereon. Accordingly, the convex portion of the filler 36 is thus prominently selectively removed faster than the other portion of the filler 36, allowing the filler 36 over the recording element 32A (the convex portion of the filler 36) to be efficiently removed. Furthermore, etching using a noble gas like an Ar gas as the process gas provides a high anisotropic etching effect, enhancing the tendency of removing the convex portion faster than the concave portion.

Note that the incident angle of the Ar gas is not always limited to 90 degrees. For example, the workpiece 10 may be irradiated with the Ar gas at a slant angle to the normal to the surface of the workpiece 10. This enhances the tendency of removing the convex portion faster than the concave portion, thus making it possible to enhance the etching rate at which the filler 36 deposited on the side of the first mask layer 22 is etched.

As shown in FIG. 9, the etching is stopped when the height of the upper surface of the filler 36 over the concave portion of the concavo-convex pattern of the recording layer 32 generally matches the height of the upper surface of the stopping film 35. The excessive portion of the filler 36 above the recording element 32A is generally removed. Meanwhile, the first mask layer 22 is removed at the peripheral portion faster than at the other portion, but remains on the stopping film 35 while completely covering the stopping film 35. Accordingly, the first mask layer 22 protects the recording element 32A from being etched. Note that even when the peripheral portion of the first mask layer 22 has completely disappeared, the stopping film 35 protects the recording element 32A from being etched.

Etching by IBE using an Ar gas causes the DLC (the first mask layer 22) to be etched at a lower etching rate than that for the SiO₂ (the filler 36). Thus, as mentioned above, when the height of the upper surface of the filler 36 over the concave portion of the recording layer 32 generally matches the height of the upper surface of the stopping film 35, the first mask layer 22 remains while completely covering the stopping film 35. In contrast to this, it is also possible to use a reactive gas, as the process gas, which chemically reacts with the DLC to remove the DLC, thereby equalizing both the etching rates or reversing those etching rates. For example, a gas mixture of an Ar gas and an O₂ or O₃ gas can be used as the process gas, so that their flow rates are adjusted to thereby equalize both the etching rates or reverse the etching rates.

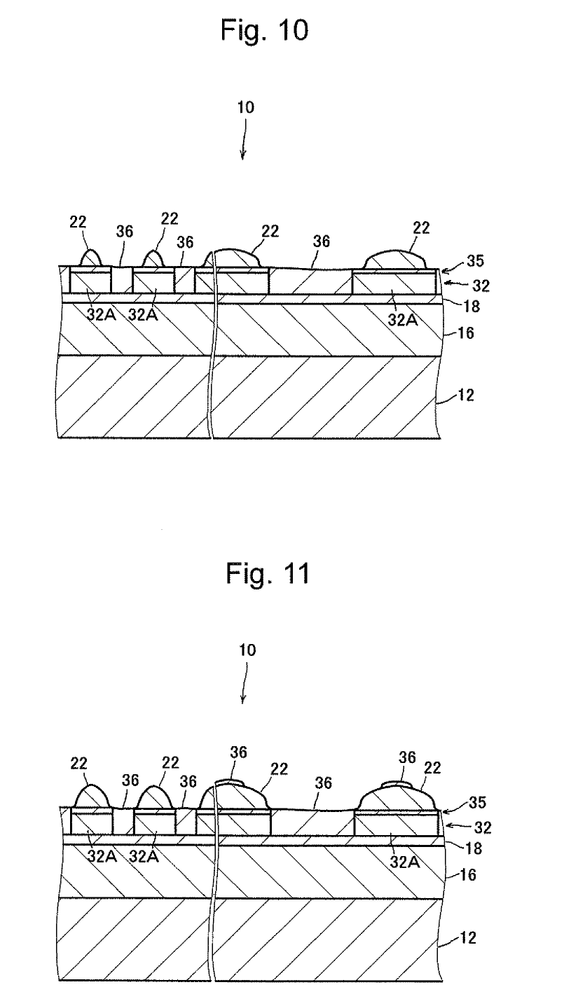

The etching rate for the DLC (the first mask layer 22) may be made higher than the etching rate for the SiO₂ (the filler 36). In this case, as shown in FIG. 10, when the height of the upper surface of the filler 36 over the concave portion of the recording layer 32 generally matches the height of the upper surface of the stopping film 35, the peripheral portion of the first mask layer 22 is removed up to the upper surface of the stopping film 35. This ensures that the filler 36 covering the side of the first mask layer 22 is removed.

When the etching rate for the first mask layer 22 is higher than the etching rate for the filler 36, the upper surface of the recording element 32A is particularly preferably covered with the stopping film 35 as in the first exemplary embodiment, to protect the recording element 32A from being etched.

Additionally, in this case, if the stopping film 35 is etched by dry etching in the filler etching step (S116) at a lower etching rate than the etching rate for the filler 36, the etching in the filler etching step (S116) can be controllably stopped with ease, preferably providing improved accuracy for the etching. This condition is met when the stopping film 35 is made of Ta, the filler 36 is made of SiO₂, and the dry etching in the filler etching step (S116) is IBE using an Ar gas because the etching rate of Ta is less than that of SiO₂.

Furthermore, both the etching rates may be equalized. In this case, as shown in FIG. 11, when the height of the upper surface of the filler 36 over the concave portion of the recording layer 32 generally matches the height of the upper surface of the stopping film 35, the first mask layer 22 remains on the stopping film 35 while completely covering the stopping film 35 and the peripheral portion is generally zero in thickness. This can ensure that the filler 36 covering the side of the first mask layer 22 is removed and the first mask layer 22 protects the recording element 32A from being etched.

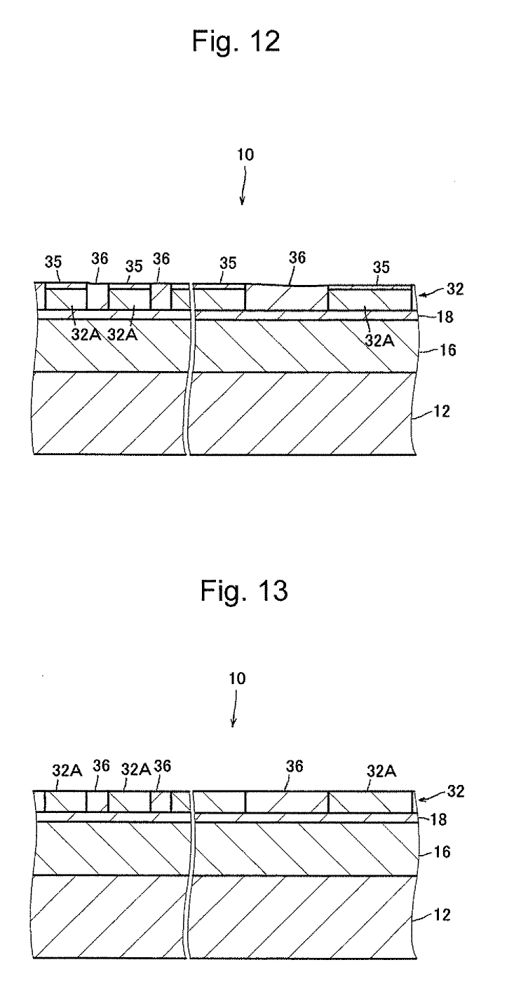

Next, as shown in FIG. 12, the first mask layer 22 is removed by dry etching in which an etching rate for the first mask layer 22 is higher than that for the filler 36 (S118: the first mask layer removing step (the mask layer removing step)). RIE using a reactive gas such as an O₂ or O₃ gas can be employed as the dry etching. This allows the first mask layer 22 over the recording element 32A (the convex portion of the concavo-convex pattern of the recording layer 32) to be removed swiftly, while preventing the processing of the filler 36 which is filled in the concave portion of the concavo-convex pattern of the recording layer 32. The first mask layer 22 over the recording element 32A may be etched temporarily at different etching rates due to variations in its width, but the first mask layer 22 is entirely removed in a short period of time. Note that although part of an excessive portion of the filler 36 may remain over the first mask layer 22 even after the filler etching step (S116), such an excessive portion of the filler 36 can also be removed in conjunction with the first mask layer 22. That is, the entire convex portion formed of the first mask layer 22 or the entire convex portion formed of the first mask layer 22 and the filler 36 remaining thereon will be removed in a short period of time irrespective of its width. Furthermore, the etching rate for the stopping film 35 is lower than that for the first mask layer 22 in the first mask layer removing step (S118). This allows the filler 36 filled in the concave portion of the concavo-convex pattern of the recording layer 32 and the stopping film 35 to be kept in such a condition that the heights of their upper surfaces generally match with each other. Accordingly, the surface of the workpiece 10 is flattened.

Next, as shown in FIG. 13, the stopping film 35 is removed by IBE using an Ar gas (S120: the stopping film removing step). Note that the upper portion of the filler 36 filled in the concave portion of the recording layer 32 is also removed in the same manner as the stopping film 35.

Next, the protective layer 38 is formed by CVD over the recording element 32A and the filler 36 (S122: the protective layer forming step). Furthermore, the lubricant layer 40 is formed over the protective layer 38 by dipping (S124: the lubricant layer forming step). As such, the magnetic recording medium 30 shown in FIG. 2 is completed.

As described above, the subsequent-stage first mask layer processing step (the subsequent-stage mask layer processing step) (S112) is provided between the recording layer processing step (S110) and the filler depositing step (S114). In the subsequent-stage mask layer processing step (S112), part of the first mask layer 22 over the recording element 32A is removed by dry etching in which an etching rate for the first mask layer 22 is higher than that for the recording layer 32 so that the first mask layer 22 remains over the recording element 32A (the convex portion of the recording layer 32). It is thus possible to reduce the protrusions and recesses of the filler 36 deposited over the recording layer 32 and the first mask layer 22 as well as to prevent the bottom of the concave portion of the filler 36 from being hidden behind the adjacent convex portions in the filler etching step (S116). Accordingly, in a region of a relatively narrow concave portion, the etching rate of the concave portion of the filler 36 can be prevented from being reduced. Thus, the etching rate of the concave portion of the filler 36 in a region, like the data region, of a relatively narrow concave portion can be brought closer to the etching rate of the concave portion of the filler 36 in a region, such as the servo region, of a relatively wide concave portion.

Note that the central portion of the convex portion tends to be removed by dry etching faster than the peripheral portion of the convex portion. Thus, the peripheral portion of the first mask layer 22 over the convex portion of the recording layer 32 may be removed faster than the central portion of the first mask layer 22 in the subsequent-stage first mask layer processing step (S112) causing the central portion of the first mask layer 22 to be etched less. In such a case, the concave portion of the filler 36 deposited over the recording layer 32 and the first mask layer 22 in the filler depositing step (S114) is not sufficiently reduced in depth. However, the peripheral portion of the first mask layer 22 over the convex portion of the recording layer 32 is removed, thereby preventing the bottom of the concave portion of the filler 36 from being hidden behind the adjacent convex portions in the filler etching step (S116). Accordingly, also in this case, the etching rate of the concave portion of the filler 36 can be prevented from being reduced.

Thereafter, the first mask layer 22 is selectively removed by etching in which an etching rate for the first mask layer 22 is higher than that for the filler 36 (S118), thereby preventing the concave portion from being etched. At the same time, the entire convex portion formed of the first mask layer 22 or the entire convex portion formed of the first mask layer 22 and the filler 36 remaining thereon can be removed in a short period of time irrespective of its width.

Furthermore, when the peripheral portion of the first mask layer 22 over the convex portion of the recording layer 32 is removed faster than the central portion of the first mask layer 22 in the subsequent-stage first mask layer processing step (S112), the convex portion formed of the first mask layer 22 or the filler 36 deposited thereon is sharpened accordingly. The wider the convex portion, the less the dry etching rate for the convex portion tends to be. On the other hand, the sharper the convex portion, the higher the etching rate tends to be. Thus, a relatively wide convex portion may be sharpened, thereby facilitating removal of the convex portion to flatten the surface.

Accordingly, even in the simultaneous presence of a region, like the servo region, of relatively wide convex and concave portions of the recording layer 32 and a region, like the data region, of relatively narrow convex and concave portions of the recording layer 32, it is possible to sufficiently reduce variations in surface roughness. This allows the magnetic recording medium 30 to be provided with sufficiently flattened surface, thereby ensuring good head flying characteristics.

Furthermore, when the oxygen-based gas is used as the reactive gas in the subsequent-stage first mask layer processing step (S112), the side of the recording element 32A can be oxidized to enhance the coercivity of the recording element 32A. Enhancing the coercivity in this manner can serve to prevent erroneous recording of information on the recording elements 32A adjacent to the target recording element 32A. Alternatively, when the recording layer 32 is processed so that the recording layer 32 remains at the bottom of the concave portion of the recording layer 32, and the fluorine-based gas, the chlorine-based gas, or the nitrogen-based gas is used as the reactive gas in the subsequent-stage first mask layer processing step (S112), the magnetism of side portion of the recording element 32A and a portion remaining at the bottom of the concave portion of the recording layer 32 can be eliminated, thereby magnetically clearly separating the adjacent recording elements 32A. Accordingly, the magnetic recording medium 30 can have good recording/reproducing characteristics.

Furthermore, when the recording layer 32 is processed so that the recording layer 32 remains at the bottom of the concave portion of the recording layer 32, the step height of the protrusions and recesses of the recording layer 32 is reduced, thereby facilitating the flattening accordingly.

Furthermore, the filler etching step (S116) and the first mask layer removing step (S118) are performed with the recording element 32A covered with the stopping film 35. Thus, in these steps, the upper surface of the recording element 32A is never etched, thus never causing deterioration in the magnetic property. That is, the magnetic recording medium 30 has good recording/reproducing characteristics in this regard as well.

Furthermore, the method for manufacturing a magnetic recording medium according to the first exemplary embodiment performs any of the steps by dry etching, thus providing better productivity as compared with the combination of dry etching and wet etching.

Note that in the first exemplary embodiment, by way of example, the first mask layer 22 is made of a material mainly composed of carbon, such as DLC. However, the first mask layer 22 may also be formed of another material so long as the material can be etched at a lower etching rate than that for the recording layer 32 in the recording layer processing step (S110) and at a higher etching rate than that for the recording layer 32 in the subsequent-stage mask layer processing step (S112). Table 1 shows examples of combinations of materials of the first mask layer 22, dry etching methods employed in the recording layer processing step (S110), and dry etching methods employed in the subsequent-stage mask layer processing step (S112). The material of the first mask layer 22 is etched at a lower etching rate than that for the recording layer 32 in the recording layer processing step (S110) and is etched at a higher etching rate than that for the recording layer 32 in the subsequent-stage mask layer processing step (S112) in each of the combinations.

TABLE 1

| | | | | | | | |
|---|---|---|---|---|---|---|---|
| Material | First mask layer | DLC, C | SiO₂, | C, Tasi, | SiO₂, | Tasi, | SiO₂, Si, |
| | | | Si, ITO, | TiN, Ta, | Si, ITO, | TiN, Ta, | Tasi, TiN, |
| | | | MgO | ZrO₂, | MgO, | ZrO₂, WO₂ | Ta, ITO, |
| | | | | WO₂, Al₂O₃ | Al₂O₃ | | MgO ZrO₂, |
| | | | | | | | WO₂, Al₂O₃ |

| | | | | | | |
|---|---|---|---|---|---|---|
| Filler | SiO₂, Si, | Tasi, | SiO₂, | Cu | Cr | Cu, Cr |
| | Tasi, TiN, Ta, | TiN, | Si, ITO, | | | |
| | ITO, MgO, Nb, | Ta, Nb, | MgO, Cr | | | |
| | ZrO₂, WO₂, | ZrO₂, | | | | |
| | Al₂O₃, Cr, Ti, | WO₂, | | | | |
| | Tisi | Al₂O₃ | | | | |

| Type of | Recording layer | IBE using noble gas such as Ar, Kr, Xe, or Ne | |
|---|---|---|---|
| dry | processing step | | |
| etching | Subsequent-stage | Dry etching using oxygen- | Dry etching using halogen-based gas |
| | mask layer | based gas such as O₂ or O₃ | (fluorine-based gas such as SF₆, CF₄, or |
| | processing step | gas; halogen-based gas | C₂F₆) (chlorine-based gas such as Cl₂ or |
| | | (fluorine-based gas such as | BCl₃) |
| | | SF₆, CF₄, or C₂F₆) | |
| | | (chlorine-based gas such as | |
| | | Cl₂ or BCl₃); or nitrogen- | |
| | | based gas such as N₂ or NH₃ | |
| | | gas | |

| | | | | |
|---|---|---|---|---|
| Filler | Process gas | Oxygen- | Noble gas such as Ar, Kr, Xe, or Ne | Halogen- |
| etching | | based gas | | based |
| step | | such as O₂ | | gas |
| | | or O₃ gas; | | such as |
| | | or | | SF₆, |
| | | nitrogen- | | CF₄, |
| | | based gas | | C₂F₆, |
| | | such as N₂ | | Cl₂ or |
| | | or NH₃ gas | | BCl₃ |

| | | | | | | |
|---|---|---|---|---|---|---|
| Incident | Upper | +90° | +15° | +90° | +15° | +90° |
| angle | limit | | | | | |
| | Lower | −10° | −10° | −10° | −10° | −10° |
| | limit | | | | | |

| | | | | | | | | |
|---|---|---|---|---|---|---|---|---|
| Etching | First | High | Low | High | Low | High | Low | High |
| rate | mask | | | | | | | |
| | layer | | | | | | | |
| | Filler | Low | High | Low | High | Low | High | Low |

| | | |
|---|---|---|
| Mask layer removing | Dry etching using oxygen- | Dry etching using halogen-based gas |
| step | based gas such as O₂ or O₃ | such as SF₆, CF₄, C₂F₆, Cl₂ or BCl₃ |
| | gas; or nitrogen-based gas | |
| | such as N₂ or NH₃ gas | |

ITO: tin-doped indium oxide

Furthermore, in the first exemplary embodiment, the IBE using an Ar gas or a gas mixture of Ar and O₂ or O₃ is shown, by way of example, as the dry etching method for the filler etching step (S116). However, the IRE may also be performed using another noble gas such as Kr or Xe. Furthermore, for example, another dry etching may also be employed, for example, the RIE using an oxygen-based gas such as O₂ or O₃; or a halogen-based reactive gas such as SF₆, CF₄, or C₂F₆; or the RIE using a gas mixture of the reactive gas and a noble gas.

Table 1 also shows examples of combinations of dry etching methods employed in the filler etching step (S116), materials for the filler 36, and the materials for the first mask layer 22; and magnitude relations between the etching rates of the filler 36 and the etching rates of the first mask layer 22 in the filler etching step (S116).

Note that although Table 1 shows such an example in which one type of process gas is singly used in the filler etching step (S116), the etching rate is adjustable by adjusting the incident angle of the process gas or by adjusting the mixing ratio using a gas mixture of the reactive gas, such as an oxygen-based gas or a halogen gas, and a noble gas. For example, the magnitude relation between the etching rate for the first mask layer 22 and the etching rate for the filler 36 can be adjusted, and the etching rate for the first mask layer 22 and the etching rate for the filler 36 can also be made generally equal to each other.

Furthermore, in the first exemplary embodiment, such an example has been shown in which the filler 36 is formed of SiO₂, the first mask layer 22 is made of DLC, and the dry etching method employed in the first mask layer removing step (S118) is RIF using the O₂ or O₃ gas as the reactive gas. However, the material of the filler 36, the material of the first mask layer 22, and the dry etching method employed in the first mask layer removing step (S118) are not limited to particular ones so long as such a combination is selected to etch the first mask layer 22 at a higher etching rate than that for the filler 36. For example, the filler 36 may also be made of another material such as another oxide, nitride such as TiN, non-magnetic metal such as Ta, Ti, or Cr, or a non-magnetic material such as TiSi, TaSi, or Si. Furthermore, depending on the use of the magnetic recording medium, the filler 36 may also be made of a soft magnetic material or the like. Furthermore, the first mask layer 22 may also be made of a metal material or resin such as photoresist. Furthermore, the dry etching method employed in the first mask layer removing step (S118) may use a halogen-based gas as the reactive gas. Table 1 also shows preferable examples of combinations of the materials of the filler 36, the materials of the first mask layer 22, and dry etching method employed in the first mask layer removing step (S118).

A description will now be made to a second exemplary embodiment of the present invention.

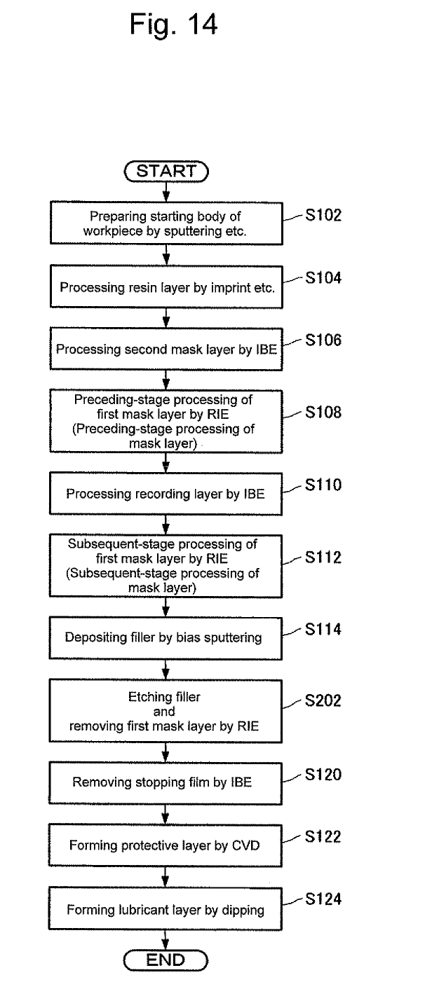

In the first exemplary embodiment, the excessive portion of the filler 36 and the first mask layer 22 are removed in two steps: the filler etching step (S116) and the first mask layer removing step (S118). In contrast to this, as shown in the flowchart of FIG. 14, the second exemplary embodiment is characterized in that the excessive portion of the filler 36 and the first mask layer 22 are removed only in a first mask layer removing step (S202). The other steps are the same as those of the first exemplary embodiment and thus their explanations will be omitted, as appropriate.

As shown in FIG. 8, in the first mask layer removing step (S202) of the second exemplary embodiment, the filler 36 has been deposited to fill the concave portion of the recording layer 32 with the filler 36. Under this condition, the excessive portion of the filler 36 and the first mask layer 22 are removed by dry etching method using a reactive gas that chemically reacts with the first mask layer 22 to remove the first mask layer, in which an etching rate for the first mask layer 22 is higher than that for the filler 36.

For example, this dry etching can be RIE using a gas mixture of an Ar gas and O₂ or O₃ gas as the process gas. The flow rate of the gas mixture can be regulated to thereby adjust the etching rate for the filler 36 and the first mask layer 22. More specifically, the ratio of Ar gas and O₂ gas can be set approximately to 3 (Ar): 2 (O₂) or a ratio with a higher proportion of O₂, thereby providing a higher etching rate for DLC than that for SiO₂. Note that the etching rate may slightly vary depending on the incident angle of the process gas.

When the height of the upper surface of the filler 36 over the concave portion of the recording layer 32 is generally equal to the height of the upper surface of the stopping film 35, the dry etching is stopped. As a result, the first mask layer 22 and the excessive portion of the filler 36 over the recording element 32A can be completely removed to flatten the surface as shown in FIG. 12.

Note that the thickness of the first mask layer 22 to be left over the recording element 32A and the thickness of the filler 36 to be deposited are adjusted in advance. This is done so that the upper surface of the filler 36 filled in the concave portion of the recording layer 32 generally matches the upper surface of the stopping film 35 within an infinitesimal period of time after the first mask layer 22 over the recording element 32A has been completely removed.

If the etching rate for the stopping film 35 is lower than that for the filler 36 in the dry etching in the first mask layer removing step (S202), it is easy to provide control so that the upper surface of the filler 36 filled in the concave portion generally matches the upper surface of the stopping film 35. When the stopping film 35 is made of Ta, the filler 36 is made of SiO₂, and the dry etching in the first mask layer removing step (S202) is reactive ion beam etching using a gas mixture of an Ar gas and O₂ or O₃ gas, the condition above is satisfied because the etching rate of Ta is lower than that of SiO₂.

As such, the first mask layer 22 and the excessive portion of the filler 36 can be removed in one step, thereby providing improved productivity.

Note that in the second exemplary embodiment, such an example is shown in which the filler 36 is made of SiO₂, the first mask layer 22 is made of DLC, and reactive ion beam etching using a process gas containing O₂ or O₃ is employed in the first mask layer removing step (S202), in which an etching rate for the first mask layer 22 is higher than that for the filler 36. However, the material of the filler 36, the material of the first mask layer 22, and the dry etching method for the first mask layer removing step (S202) are not limited to particular ones so long as such a combination is chosen as to allow the first mask layer 22 to be etched at a higher etching rate than that for the filler 36. Several preferable examples of the combinations are shown in Table 2.

TABLE 2

| Material | First mask layer | DLC, C | | SiO₂, | SiO₂, Si, | SiO₂, Si, Tasi, |
|---|---|---|---|---|---|---|
| | | | | Si, | ITO, MgO, | TiN, Ta, ITO, |
| | | | | ITO, | Al₂O₃ | Mgo, ZrO₂, WO₂, |
| | | | | MgO | | Al₂O₃ |
| | Filler | SiO₂, Si, Tasi, | Tasi, | Cu | Cr | Cu, Cr |
| | | TiN, Ta, ITO, | TiN, | | | |
| | | MgO, Nb, ZrO₂, | Ta, Nb, | | | |
| | | WO₂, Al₂O₃, Cr, | ZrO₂, | | | |
| | | Ti, Tisi | WO₂, | | | |
| | | | Al₂O₃ | | | |

| Type of | Recording layer processing | IBE using noble gas such as Ar, Kr, Xe, or Ne | |
|---|---|---|---|
| dry | step | | |
| etching | Subsequent-stage mask | Dry etching using | Dry etching using halogen- |
| | layer processing step | oxygen-based gas | based gas (fluorine-based gas |
| | | such as O₂ or O₃ | Such as SF₆, CF₄, or C₂F₆) |
| | | gas; halogen-based | (chlorine-based gas such as |
| | | gas (fluorine-based | Cl₂ or BCl₃) |
| | | gas such as SF₆, | |
| | | CF₄, or C₂F₆) | |
| | | (chlorine-based gas | |
| | | such as Cl₂ or | |
| | | BCl₃); or nitrogen- | |
| | | based gas such as N₂ | |
| | | or NH₃ gas | |

| | | | | |
|---|---|---|---|---|
| Mask layer | Process gas | Oxygen-based | Noble gas such as | Halogen-based |
| removing | | gas such as | Ar, Kr, Xe, or Ne | gas such as |
| step | | O₂ or O₃ gas, | | SF₆, CF₄, C₂F₆, |
| | | or nitrogen- | | Cl₂ or BCl₃ |
| | | based gas | | |
| | | such as N₂ | | |
| | | or NH₃ gas | | |

| | | | | |
|---|---|---|---|---|
| Incident | Upper | +90° | +15° | +90° |
| angle | limit | | | |
| | Lower | −10° | −10° | −10° |
| | limit | | | |

Note that although Table 2 shows such an example in which one type of process gas is singly used, a gas mixture of a reactive gas, like an oxygen-based gas or a halogen-based gas, and a noble gas may also be employed as in the aforementioned first exemplary embodiment so long as the magnitude relation between the etching rate for the first mask layer 22 and the etching rate for the filler 36 is not reversed.

Furthermore, the type of the process gas may be changed on the way of the filler etching step (S116) of the first exemplary embodiment and the first mask layer removing step (S202) of the second exemplary embodiment. For example, the filler etching step (S116) of the first exemplary embodiment or the first mask layer removing step (S202) of the second exemplary embodiment may be divided into two steps. Then, in the former step, the first mask layer 22 may be etched at the same etching rate as or at a lower etching rate than that for the filler 36 using a noble gas, like an Ar gas, as the process gas. In the latter step, the first mask layer 22 may be etched at a higher etching rate than that for the filler 36 using a gas mixture of an Ar gas and a gas chemically reacting the first mask layer such as an O₂ or O₃ gas. Furthermore, a gas mixture containing a plurality of gases may also be used as the process gas in the filler etching step (S116) of the first exemplary embodiment and the first mask layer removing step (S202) of the second exemplary embodiment. The gas mixture ratio may be gradually changed in the course of these steps. For example, in these steps, a gas mixture of a noble gas and an O₂ or O₃ gas may be used as the process gas, so that the flow rate of the O₂ or O₃ gas is gradually increased.

A description will now be made to a third exemplary embodiment of the present invention.

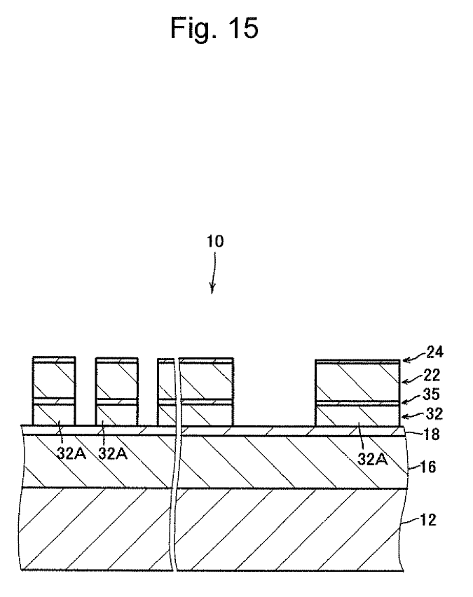

In the first and second exemplary embodiments, the second mask layer 24 has vanished at the end of the recording layer processing step (S110) as shown in FIG. 6. In contrast to this, as shown in FIG. 15, the third exemplary embodiment is characterized in that the second mask layer 24 remains (on the first mask layer 22) over the recording element 32A at the end of the recording layer processing step (S110), and the second mask layer 24 remaining over the recording element 32A is removed in conjunction with the first mask layer 22 in the subsequent-stage first mask layer processing step (S112). The other steps are the same as those of the first and second exemplary embodiments and thus their explanations will be omitted, as appropriate.

For example, suppose that the second mask layer 24 is made of Ta, an oxidizing gas such as an O₂ or O₃ gas is used in the preceding-stage first mask layer processing step (S108), and the recording layer 32 is etched by IBE using an Ar gas in the recording layer processing step (S110). In this case, as shown in FIG. 15, the second mask layer 24 remains over the recording element 32A at the end of the recording layer processing step (S110). This is thought to be because the surface of the second mask layer 24 is oxidized in the preceding-stage first mask layer processing step (S108) and thus etched at a considerably decreased etching rate by IBE using an Ar gas, causing the second mask layer 24 to remain over the recording element 32A at the end of the recording layer processing step (S110).

Note that although the stopping film 35 in the concave portion is also exposed temporarily to the process gas in the preceding-stage first mask layer processing step (S108), the stopping film 35 in the concave portion is easily removed in the recording layer processing step (S110) even if the stopping film 35 is made of Ta. This is thought to be because the stopping film 35 in the concave portion is exposed to the process gas in a shorter period of time than the second mask layer 24, thus preventing or suppressing a decrease in the etching rate by IBE using an Ar gas.

As such, the second mask layer 24 remains on the first mask layer 22 over the recording element 32A at the end of the recording layer processing step (S110). Thus, in the recording layer processing step (S110), the shape of the first mask layer 22 is maintained in the pattern as formed in the preceding-stage first mask layer processing step (S108), and the recording layer 32 is etched according to the shape of this pattern.

Note that since the second mask layer 24 is present on the first mask layer 22 over the recording element 32A until the recording layer processing step (S110) ends, the second mask layer 24 can also serve as the mask during the etching of the recording layer 32 in the recording layer processing step (S110). The presence of the first mask layer 22, which is thicker than the second mask layer 24, between the second mask layer 24 and the recording layer 32 allows the side of the recording element 32A to be formed approximately perpendicularly (to the surface of the workpiece 10). Accordingly, even in such a case as in the third exemplary embodiment where the second mask layer 24 remains on the first mask layer 22 at the end of the recording layer processing step (S110), the first mask layer 22 can serve as the mask during the etching of the recording layer 32 in the recording layer processing step (S110). That is, in the recording layer processing step (S110), the recording layer 32 is etched based on the first mask layer 22.

In the subsequent-stage first mask layer processing step (S112), the second mask layer 24 remaining over the recording element 32A as well as part of the first mask layer 22 over the recording element 32A can be removed through use of a halogen-based gas including a fluorine-based gas such as SF₆, CF₄, or C₂F₆, or a chlorine-based gas such as Cl₂ or BCl₃.

A description will now be made to a fourth exemplary embodiment of the present invention.

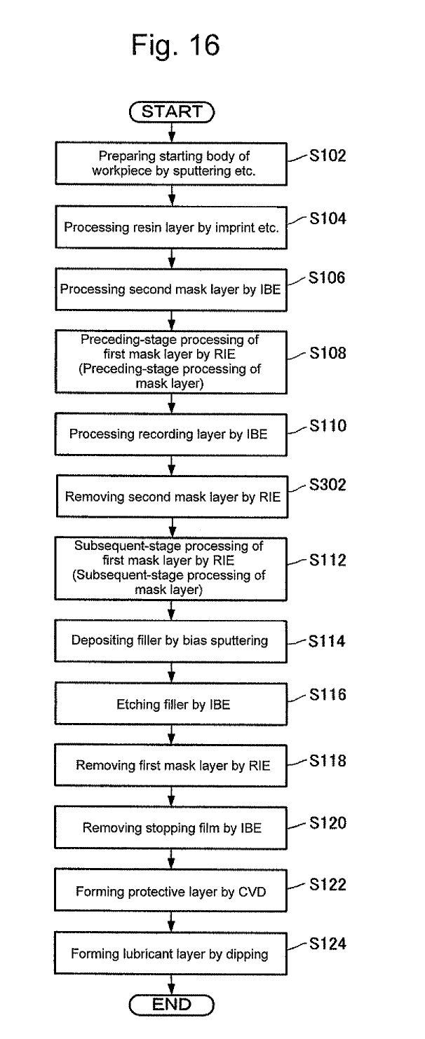

In the third exemplary embodiment, the second mask layer 24 remaining over the recording element 32A is removed in conjunction with the first mask layer 22 in the subsequent-stage first mask layer processing step (S112). In contrast to this, as shown in the flowchart of FIG. 16, the fourth exemplary embodiment is characterized by providing a second mask layer removing step (S302) for removing the second mask layer 24 remaining over the recording element 32A between the recording layer processing step (S110) and the subsequent-stage first mask layer processing step (S112). The other steps are the same as those of the third exemplary embodiment and thus their explanations will be omitted, as appropriate

As mentioned above, the second mask layer removing step (S302) is provided separately from the subsequent-stage first mask layer processing step (S112). This makes it possible to set the etching conditions, such as the type of the process gas in the subsequent-stage first mask layer processing step (S112), to those that are suitable to remove part of the first mask layer 22 over the recording element 32A without taking into account the removal of the second mask layer 24.

FIG. 16 shows, for convenience purposes, an example in which the filler etching step (S116) and the first mask layer removing step (S118) are separately provided as in the manufacturing method according to the first exemplary embodiment shown in FIG. 3. But, like the manufacturing method according to the second exemplary embodiment shown in FIG. 14, the first mask layer removing step (S202) can be configured to serve also as the filler etching step.

Note that in the first to fourth exemplary embodiments, the stopping film 35 is made of Ta, by way of example. However, the stopping film 35 may also be made of another non-magnetic material so long as the material has a low etching rate in the filler etching step (S116) and the first mask layer removing step (S118 and S202).

Furthermore, in the first, third, and fourth exemplary embodiments, the stopping film 35 serves as the stopping film for the filler etching step as well as the stopping film for the first mask layer removing step. However, a stopping film for the filler etching step and another stopping film for the first mask layer removing step may be formed separately. Furthermore, in the first, third, and fourth exemplary embodiments, damage to the recording layer 32 caused only by either one of the filler etching step (S116) and the first mask layer removing step (S118) may be considered to be problematic without considering damage to the recording layer 32 resulting from the other step to be problematic. In this case, the stopping film 35 may be made of a material that is etched at a lower etching rate only in the step where damage to the recording layer 32 due to etching is considered to be problematic.

Furthermore, in the first to fourth exemplary embodiments, the stopping film removing step (S120) is provided between the first mask layer removing step (S118 and 5202) and the protective layer forming step (S122), so that the protective layer 38 is formed after the stopping film 35 over the recording element 32A has been removed. However, the stopping film removing step (S120) may be eliminated to form the protective layer 38 on top of the stopping film 35 so long as the recording/reproducing characteristics are not seriously affected. The stopping film 35 has a low etching rate during the etching in the first mask layer removing step (S118 and S202) and thus its thickness can be reduced accordingly. For example, a stopping film 35 as thin as 2 nm or less remaining over the recording element 32A does not have serious effects on the recording/reproducing characteristics.

Furthermore, the stopping film 35 may be eliminated, for example, when the first mask layer 22 can sufficiently protect the recording element 32A from being etched or the etching in the first mask layer removing step (S118 and S202) and the like has sufficiently insignificant effects on the recording element 32A. In this case, the excessive portion of the filler 36 may be etched in the filler etching step (S116) or the first mask layer removing step (S202) so as to align the upper surface of the filler 36 filled in the concave portion of the recording layer 32 with the upper surface of the recording element 32A.

Furthermore, suppose that the stopping film 35 is eliminated and thus the etching in the first mask layer removing step (S118 and S202) and the like has adverse effects on the upper surface of the recording element 32A. Even in this case, the upper surface and its vicinity of the recording element 32A, affected by the etching in the first mask layer removing step (S118 and 5202) and the like, can be removed after the first mask layer removing step (S118 and S202), for example, by IBE using a noble gas as in the stopping film removing step (S120), thereby providing good recording/reproducing characteristics.

Furthermore, in the first to fourth exemplary embodiments, the first mask layer 22, the second mask layer 24, and the resin layer 26 are formed over the recording layer 32 of the continuous film, and then the recording layer 32 is processed in the concavo-convex pattern by three-stage dry etching. However, materials, the number of stacked layers and/or thicknesses of the resin layer and/or the mask layer are not limited to particular ones so long as the recording layer 32 can be processed in the concavo-convex pattern with high accuracy. For example, the second mask layer may be eliminated in the first and second exemplary embodiments. Furthermore, both the second mask layer and the first mask layer may be eliminated to form directly a resin layer on the continuous recording layer, so that the recording layer is processed in the concavo-convex pattern using the resin layer as the mask layer. That is, the resin layer may serve also as the mask layer. Furthermore, the type of dry etching may also be changed as appropriate depending on the structure of the mask layers.

Furthermore, in the first to fourth exemplary embodiments, the filler 36 is deposited by bias sputtering. However, for example, the filler 36 may also be deposited using another deposition technique, for example, by sputtering with no bias power applied, by CVD, or by IBD.

Furthermore, the filler etching step (S116) is executed immediately after the filler depositing step (S114) in the first, third, and fourth exemplary embodiments, and the first mask layer removing step (S202) is performed immediately after the filler depositing step (S114) in the second exemplary embodiment. However, after the filler 36 has been deposited, a cladding made of a material different from that of the filler 36 may be deposited on the filler 36, and then the filler etching step (S116) or the first mask layer removing step (S202) may be executed. In this case, the material of the cladding and the etching method are preferably chosen so that the cladding is etched at a lower etching rate than that for the filler 36 in the filler etching step (S116) (the first mask layer removing step (S202) in the second exemplary embodiment). Furthermore, in this case, the concave portion of the recording layer 32 may be filled with both the filler 36 and the cladding. For example, in the filler depositing step (S114), the filler 36 may be deposited in the concave portion to a thickness that is slightly less than the depth of the concave portion of the recording layer 32 and then the cladding is deposited thereon, thereby filling the concave portion with both the filler 36 and the coating.

Furthermore, in the first to fourth exemplary embodiments, the soft magnetic layer 16 and the seed layer 18 are formed under the recording layer 32. However, the structure of the layers under the recording layer 32 may be changed appropriately depending on the type of the magnetic recording medium. For example, an underlayer or an antiferromagnetic layer may be formed under the soft magnetic layer. Alternatively, any one of the soft magnetic layer 16 and the seed layer 18 may be eliminated. Or, the recording layer may be formed directly on the substrate.

Furthermore, in the first to fourth exemplary embodiments, the magnetic recording medium 30 is provided, on one side of the substrate 12, with the recording layer 32 and the like. However, various exemplary embodiments of the present invention are also applicable to manufacturing of a double-sided magnetic recording medium with a recording layer provided on both sides of the substrate.

Furthermore, in the first to fourth exemplary embodiments, the magnetic recording medium 30 is a discrete track medium with the data region portion of the recording layer 32 formed in a concavo-convex pattern corresponding to the tracks. However, various exemplary embodiments of the present invention are also applicable to a patterned medium with the data region portion of the recording layer formed in a concavo-convex pattern corresponding to the recording bits. Furthermore, for example, various exemplary embodiments of the present invention are also applicable to manufacturing of a magnetic recording medium having a recording layer, like a helical spiral recording layer, which is continuously formed over part of the substrate. Furthermore, various exemplary embodiments of the present invention are also applicable to manufacturing of a magnetic recording medium having a longitudinal recording layer. Furthermore, various exemplary embodiments of the present invention are also applicable to manufacturing of a magneto-optical disk such as MO disks, a heat-assisted magnetic disk which employs both magnetism and heat, and a magnetic recording medium with a recording layer in a concavo-convex pattern, having a shape other than the disc, such as a magnetic tape.

### Working Example

According to the aforementioned first exemplary embodiment, four samples W1 to W4 of the magnetic recording medium 30 were prepared. First, in the starting body of workpiece preparing step (S102), the starting body of the workpiece 10 configured as shown below was prepared.

Material of the substrate 12: glass
Diameter of the substrate 12: 48 mm (1.89 inch)
Material of the recording layer 32: CoCrPt alloy
Thickness of the recording layer 32: 20 nm
Material of the stopping film 35: Ta
Thickness of the stopping film 35: 2 nm
Material of the first mask layer 22: DLC
Thickness of the first mask layer 22: 30 nm
Material of the second mask layer 24: Ni
Thickness of the second mask layer 24: 4 nm
Material of the resin layer 26: ultraviolet curable resin
Thickness of the resin layer 26: 40 nm

In the resin layer processing step (S104), a pattern corresponding to the concavo-convex pattern of the recording layer 32 was transferred by imprinting to the resin layer 26. Note that only in an annular area of a radius of 10 to 23 mm from the center of rotation, a concavo-convex pattern of a track pitch of 78 nm was formed in the data region within the annular area. Furthermore, a concavo-convex pattern corresponding to a servo pattern for a frequency of 53 MHz was formed in the servo region within this annular area.

In the second mask layer processing step (S106), the second mask layer 24 was etched by IBE using an Ar gas based on the resin layer 26, thereby processing the second mask layer 24 into a pattern corresponding to the concavo-convex pattern of the recording layer 32. At this time, the bottom of the concave portion of the resin layer 26 was also removed.

In the preceding-stage first mask layer processing step (the preceding-stage mask layer processing step) (S108), the first mask layer 22 was etched by IBE using an O₂ gas based on the second mask layer 24, thereby processing the first mask layer 22 into a pattern corresponding to the concavo-convex pattern of the recording layer 32.

In the recording layer processing step (S110), the recording layer 32 and the stopping film 35 were etched by IBE using an Ar gas based on the first mask layer 22 and thereby processed into an intended concavo-convex pattern. The etching was stopped when the etching was carried out to the boundary between the recording layer 32 and the seed layer 18. Note that at the end of this step, the second mask layer 24 has been completely disappeared, allowing the upper surface and the side surface of the first mask layer 22 to be completely exposed. The remaining first mask layer 22 was 29 nm in thickness, and the step height of the concavo-convex pattern was 51 nm. The conditions for the IBE were as shown below.

Source power: 200 W
Grid voltage: 1000 V
Suppressor voltage: −1500 V
Pressure in chamber: 0.02 Pa
Etching time: 16 sec
Incident angle of Ar gas: 90 degrees

Note that under these conditions, the etching rate of the first mask layer 22 is 0.1 nm/sec or less, and the etching rate of the recording layer 32 is 1.4 nm/sec.

In the subsequent-stage first mask layer processing step (the subsequent-stage mask layer processing step) (S112), part of the first mask layer 22 over the recording element 32A was removed by RIE using an O₂ gas. At the end of this step, the remaining first mask layer 22 was 19 nm in thickness. The step height of the concavo-convex pattern was 41 nm. The conditions for the RIE were as shown below.

Source power: 1000 W
Bias voltage: 20 V
Pressure in chamber: 2.0 Pa
Etching time: 10 sec

Note that under these conditions, the etching rate of the first mask layer 22 is 1.0 nm/sec, and the etching rate of the recording layer 32 is 0.1 nm/sec or less.

In the filler depositing step (S114), the filler 36 of SiO₂ was deposited by bias sputtering over the recording layer 32 and the first mask layer 22 to fill the concave portion of the concavo-convex pattern of the recording layer 32 with the filler 36. The deposited filler 36 (the portion deposited at the concave portion of the recording layer 32) was 50 nm in thickness. The conditions for the bias sputtering were as shown below.

Source power: 500 W
Bias voltage: 16 V
Pressure in chamber: 9.0 Pa
Deposition time: 130 sec

In the filler etching step (S116), the excessive portion of the filler 36 formed over the recording element 32A (the convex portion of the recording layer) was removed by IBE using an Ar gas. The excessive portion of the filler 36 formed over the recording element 32A was completely removed at the end of this step, allowing the upper surface and the side surface of the first mask layer 22 remaining over the recording element 32A to be completely exposed.

The etching was stopped when in the data region, the upper surface of the filler 36 filled in the concave portion between the recording elements 32A and the upper surface of the stopping film 35 on the recording element 32A generally matched with each other. The conditions for the IBE were as shown below.

Source power: 200 W
Grid voltage: 500 V
Suppressor voltage: −500 V
Pressure in chamber: 0.01 Pa
Etching time: 200 sec
Incident angle of Ar gas: 90 degrees

In the first mask layer removing step (S118), the first mask layer 22 was removed by RIE using an O₂ gas. At the end of this step, in the data region, the upper surface of the filler 36 filled in the concave portion between the recording elements 32A and the upper surface of the stopping film 35 on the recording element 32A generally matched with each other. The conditions for the RIE were as shown below.

Source power: 1000 W
Bias voltage: 20 V
Pressure in chamber: 2.0 Pa
Etching time: 26 sec

Note that under these conditions, the etching rate of the first mask layer 22 is 0.7 nm/sec, and the etching rate of the filler 36 is 0.1 nm/sec or less.

In the stopping film removing step (S120), the stopping film 35 was removed by IBE using an Ar gas. Furthermore, the upper portion of the filler 36 filled in the concave portion of the recording layer 32 was also removed like the stopping film 35. The conditions for the IBE were as shown below.

Source power: 200 W
Grid voltage: 500 V
Suppressor voltage: −500 V
Pressure in chamber: 0.02 Pa
Etching time: 14 sec
Incident angle of Ar gas: 90 degrees

In the protective layer forming step (S122), the protective layer 38 of DLC was formed by CVD over the upper surface of the recording element 32A and the filler 36. The deposited protective layer 38 was 3 nm in thickness.

The surfaces of the four samples W1 to W4 of the magnetic recording medium 30 with the protective layer 38 formed in this manner were observed to measure the step heights of their protrusions and recesses using an AFM (atomic force microscope). Note that no lubricant layer 40 was formed on the protective layer 38. The measured positions were located at a radius of 16 mm from the center of rotation. At the measurement positions in the data region, the radial width of the recording element 32A (width at the upper surface level) was 55 nm, and the radial width of the concave portion between the recording elements 32A (width at the upper surface level of the recording element 32A) was 23 nm. Furthermore, at the measurement positions in the servo region, the circumferential length of the 1-bit convex portion was 57 nm, and the circumferential length of the 2-bit convex portion was 114 nm. Furthermore, at the measurement positions in the servo region, the circumferential length of the 1-bit concave portion was also 57 nm, and the circumferential length of the 2-bit concave portion was also 114 nm. Table 3 shows the step heights of the protrusions and recesses in the data region and those of the 1-bit portion and the 2-bit portion in the servo region in the samples W1 to W4. Furthermore, Table 3 also shows the differences between the step heights of the protrusions and recesses of the 2-bit portion in the servo region and those in the data region of the samples W1 to W4.

TABLE 3

| | | Step height (nm) | | | |
|---|---|---|---|---|---|
| | | Data region | Servo region | | |
| Sample | | track | 1 bit | 2 bit | 2 bit-track |
| Working | W1 | 0.2 | 1.8 | 2.5 | 2.3 |
| Example | W2 | 0.1 | 2.5 | 3.4 | 3.3 |
| | W3 | 0.1 | 2.1 | 2.8 | 2.7 |
| | W4 | 0.2 | 2.3 | 3.2 | 3.0 |
| | Average | 0.15 | 2.18 | 2.98 | 2.83 |
| Comparative | C1 | 0.1 | 5.2 | 9.3 | 9.2 |
| Example | C2 | 0.2 | 5.8 | 8.9 | 8.7 |
| | C3 | 0.1 | 5.3 | 9.0 | 8.9 |
| | C4 | 0.2 | 5.5 | 9.2 | 9.0 |
| | Average | 0.15 | 5.45 | 9.10 | 8.95 |

### Comparative Example

In contrast to the aforementioned Working Example, the subsequent-stage first mask layer processing step (the subsequent-stage mask layer processing step) (S112) was not carried out between the recording layer processing step (S110) and the filler etching step (S116). That is, with the step height of the concavo-convex pattern on the surface of the workpiece 10 being 51 nm, the filler 36 was deposited on the surface of the workpiece 10. Furthermore, in the filler etching step (S116), as with the Working Example, the etching was stopped when in the data region, the upper surface of the filler 36 filled in the concave portion between the recording elements 32A and the upper surface of the stopping film 35 on the recording element 32A generally matched with each other. However, the time required to etch the filler 36 was 239 sec, longer than 200 sec for the Working Example. Under the same conditions as those for the aforementioned Working Example except for the conditions above, four samples C1 to C4 of the magnetic recording medium 30 were manufactured in the same manner as with the aforementioned Working Example. Then, the step heights of the protrusions and recesses on the surface of the samples C1 to C4 were measured using the AFM (atomic force microscope). The measurement results are also shown in Table 3.

As shown in Table 3, the samples W1 to W4 of the Working Example and the samples C1 to C4 of the Comparative Example were all found to have a 0.2 nm or less step height of their protrusions and recesses in the data region, indicating that the data region was sufficiently flattened.

Furthermore, the samples W1 to W4 of the Working Example and the samples C1 to C4 of the Comparative Example were found to have the step heights of the protrusions and recesses in the servo region greater than the step heights of the protrusions and recesses in the data region. The concave portion of the filler 36 is thought to have been excessively etched in the servo region. This is because the width of the concave portion of the filler 36 deposited in the servo region in the filler depositing step (S114) was greater than the width of the concave portion in the data region, so that in the filler etching step (S116), the concave portion of the filler 36 in the servo region was etched at a higher etching rate than that for the concave portion of the data region.

On the other hand, the step heights of the protrusions and recesses in the servo region of the samples W1 to W4 of the Working Example were considerably less than the step heights of the protrusions and recesses in the servo region of the samples C1 to C4 of the Comparative Example. For the Working Example, part of the first mask layer 22 over the recording element 32A was removed in the subsequent-stage first mask layer processing step (the subsequent-stage mask layer processing step) (S112), and thus the protrusions and recesses of the filler 36 deposited in the filler depositing step (S114) were suppressed. Thus, in the filler etching step (S116), the bottom of the concave portion of the filler 36 is thought to be not easily hidden behind the adjacent convex portions. Accordingly, when compared with the Comparative Example, the Working Example is thought to have provided in the filler etching step (S116) a smaller difference between the etching rate of the concave portion of the filler 36 in the servo region and the etching rate of the concave portion in the data region. It is thus thought that this served to considerably reduce the step heights of the protrusions and recesses in the servo region of the samples W1 to W4 of the Working Example when compared to the step heights of the protrusions and recesses in the servo region of the samples C1 to C4 of the Comparative Example.

That is, it was confirmed that variations in surface roughness are sufficiently reduced even in the simultaneous presence of a region of a relatively wide concave and convex portion and a region of a relatively narrow concave and convex portion in the recording layer by providing the subsequent-stage first mask layer processing step (the subsequent-stage mask layer processing step) (S112) between the recording layer processing step (S110) and the filler depositing step (S114).

### INDUSTRIAL APPLICABILITY

Various exemplary embodiments of the present invention are applicable to manufacturing of magnetic recording media, which have a concavo-convex patterned recording layer, such as discrete track media or patterned media.

### REFERENCE SIGNS LIST

10—workpiece
12—substrate
16—soft magnetic layer
18—seed layer
22—first mask layer
24—second mask layer
26—resin layer
30—magnetic recording medium
32—recording layer
32A—recording element
35—stopping film
36—filler
38—protective layer
40—lubricant layer
S102—starting body of workpiece preparing step
S104—resin layer processing step
S106—second mask layer processing step
S108—preceding-stage first mask layer processing step (preceding-stage mask layer processing step)
S110—recording layer processing step
S112—subsequent-stage first mask layer processing step (subsequent-stage mask layer processing step)
S114—filler depositing step
S116—filler etching step
S118 and S202—first mask layer removing step (mask layer removing step)
S120—stopping film removing step
S122—protective layer forming step
S124—lubricant layer forming step
S302—second mask layer removing step

1. A method for manufacturing a magnetic recording medium, comprising:
a preceding-stage mask layer processing step of processing a mask layer of a workpiece into a pattern corresponding to a predetermined concavo-convex pattern, the workpiece including a substrate, a recording layer, and the mask layer;
a recording layer processing step of etching the recording layer based on the mask layer into the concavo-convex pattern by dry etching in which an etching rate for the recording layer is higher than that for the mask layer;
a subsequent-stage mask layer processing step of removing part of the mask layer over a convex portion of the recording layer by dry etching in which an etching rate for the mask layer is higher than that for the recording layer so that the mask layer remains over the convex portion of the recording layer;
a filler depositing step of depositing a filler of which material is different from a material of the mask layer over the recording layer and the mask layer to fill a concave portion of the concavo-convex pattern with the filler;
a filler etching step of removing at least part of an excessive portion of the filler formed over the convex portion of the recording layer by dry etching so as to expose at least part of the mask layer remaining over the convex portion of the recording layer; and
a mask layer removing step of flattening a surface by removing the mask layer by dry etching in which an etching rate for the mask layer is higher than that for the filler.

2. The method for manufacturing a magnetic recording medium according to claim 1 wherein
the subsequent-stage mask layer processing step is performed by dry etching using a reactive gas, the reactive gas chemically reacting with the mask layer to remove the mask layer.

3. The method for manufacturing a magnetic recording medium according to claim 2 wherein:
the material of the mask layer is mainly composed of carbon; and
the subsequent-stage mask layer processing step is performed by dry etching using a reactive gas including any one selected from the group consisting of a fluorine-based gas, a chlorine-based gas, and a nitrogen-based gas.

4. The method for manufacturing a magnetic recording medium according to claim 2 wherein:
the material of the mask layer is mainly composed of carbon; and
the subsequent-stage mask layer processing step is performed by dry etching using a reactive gas including an oxygen-based gas.

5. A method for manufacturing a magnetic recording medium, comprising:
a preceding-stage mask layer processing step of processing a mask layer of a workpiece into a pattern corresponding to a predetermined concavo-convex pattern, the workpiece including a substrate, a recording layer, and the mask layer;
a recording layer processing step of etching the recording layer based on the mask layer into the concavo-convex pattern by dry etching in which an etching rate for the recording layer is higher than that for the mask layer;
a subsequent-stage mask layer processing step of removing part of the mask layer over a convex portion of the recording layer by dry etching in which an etching rate for the mask layer is higher than that for the recording layer so that the mask layer remains over the convex portion of the recording layer;
a filler depositing step of depositing a filler of which material is different from a material of the mask layer over the recording layer and the mask layer to fill a concave portion of the concavo-convex pattern with the filler; and
a mask layer removing step of flattening a surface by removing the mask layer and an excessive portion of the filler formed over a convex portion of the recording layer by dry etching in which an etching rate for the mask layer is higher than that for the filler.
